(19) United States
(12) Patent Application Publication
(10) Pub. No.: US 2026/0062042 A1
(43) Pub. Date: Mar. 5, 2026

(54) PACKAGING SUPPORTING FRAME FOR SPRING MATTRESS AND METHOD FOR PACKAGING SPRING MATTRESS

(71) Applicant: Luhao LENG, Xiamen (CN)

(72) Inventor: Luhao LENG, Xiamen (CN)

(21) Appl. No.: 19/309,780

(22) Filed: Aug. 26, 2025

(30) Foreign Application Priority Data
Aug. 27, 2024 (CN) 202411184116.5

(51) Int. Cl. B62B 3/02; B62B 3/00; B65B 5/08; B65B 5/10

(52) U.S. Cl. CPC B62B 3/02; B62B 3/006; B65B 5/08; B65B 5/10; B62B 2202/30

(57) ABSTRACT

A packaging supporting frame for a spring mattress includes two transverse frames, two longitudinal frames, and rollers. Each of one or more bottom supporting frames is configured to be rotated to form an angle between 0°and 90°with a corresponding one of the two transverse frames. When the one or more bottom supporting frames are rotated perpendicular to the two transverse frames, two ends of each of the one or more bottom supporting frames are respectively connected to the two longitudinal frames. A length of each of the two transverse frames in a transverse direction is greater than or equal to twice a length of each of the two longitudinal frames in a longitudinal direction, and the rollers are arranged at the bottoms of the two transverse frames or bottoms of the two longitudinal frames.

### RELATED APPLICATIONS

This application claims priority to Chinese patent application number 202411184116.5, filed on Aug. 27, 2024. Chinese patent application number 202411184116.5 is incorporated herein by reference.

### FIELD OF THE DISCLOSURE

The present disclosure relates to the technical field of furniture transportation, and in particular relates to a packaging supporting frame for a spring mattress and a method for packaging the spring mattress.

### BACKGROUND OF THE DISCLOSURE

Most existing spring mattresses are single-piece, monolithic structures, resulting in large bulk and high transportation and storage costs. To enhance mattress comfort, researchers are designing removable spring modules. This allows for customized adjustment of springs in different areas of the mattress, allowing for varying firmness levels in different areas of the mattress. Furthermore, the springs can be removed for separate shipment.

Disassembling spring mattresses and shipping parts of the spring mattresses separately has greatly improved the convenience of transporting spring beds. However, there are still some problems with transportation and handling of the spring mattresses. Even with categorized packaging and transportation methods, there are still problems such as long assembly time, difficulty in disassembly and assembly, and difficulty in moving, which impacts use and adoption of the spring mattresses.

### BRIEF SUMMARY OF THE DISCLOSURE

The purpose of the present disclosure is to overcome the defects of the existing techniques and provide a packaging supporting frame for a spring mattress and a method for packaging the spring mattress, which can reduce a volume of a single package of the spring mattress, facilitate transportation and handling, save labor costs, and prevent the spring mattress from being damaged or deformed.

The technical solutions of the present disclosure are as follows:

A packaging supporting frame for a spring mattress comprises two transverse frames opposite to each other, two longitudinal frames opposite to each other, and rollers. The two longitudinal frames are configured to be folded inward.

Bottoms of the two transverse frames are connected with one or more bottom supporting frames. Each of the one or more bottom supporting frames is configured to be rotated to form an angle between 0°and 90°with a corresponding one of the two transverse frames to which a corresponding one of the one or more bottom supporting frames is connected. When the one or more bottom supporting frames are rotated perpendicular to the two transverse frames, two ends of each of the one or more bottom supporting frames in a transverse direction are respectively connected to the two longitudinal frames through a buckling structure.

Two ends of each of the transverse frames are rotatably connected to corresponding ends of the two longitudinal frames. A length of each of the two transverse frames in the transverse direction is greater than or equal to twice a length of each of the two longitudinal frames in a longitudinal direction. The rollers are arranged at the bottoms of the two transverse frames or bottoms of the two longitudinal frames.

In some possible embodiments, each of the one or more bottom supporting frames is connected to the corresponding one of the two transverse frames through one or more connecting rods, and each of the one or more bottom supporting frames and the corresponding one of the two transverse frames are respectively connected to two ends of each of the one or more connecting rods. The corresponding one of the one or more bottom supporting frames is configured to be rotated relative to the one or more connecting rods.

In some possible embodiments, a body of the one or more connecting rods and the corresponding one of the two transverse frames are in a same vertical plane, and a connecting protrusion protruding inwardly is formed at one end of each of the one or more connecting rods away from the corresponding one of the two transverse frames. The corresponding one of the one or more bottom supporting frames is rotatably connected to the connecting protrusion.

In some possible embodiments, a length of each of the one or more bottom supporting frames in the transverse direction is less than or equal to a distance between the two longitudinal frames.

In some possible embodiments, a connection point between the corresponding one of the one or more bottom supporting frames and the one or more connecting rods is higher than the bottoms of the two longitudinal frames in a height direction. When the one or more bottom supporting frames are parallel to the two transverse frames and the two longitudinal frames are folded inward, the one or more bottom supporting frames and the two longitudinal frames do not interfere with each other.

In some possible embodiments, the one or more connecting rods are two connecting rods, and each of the one or more bottom supporting frames is connected to the corresponding one of the two transverse frames through the two connecting rods.

In some possible embodiments, the buckling structure comprises a female buckling member arranged at the two ends of the corresponding one of the one or more bottom supporting frames in the transverse direction and a sub-buckling member formed by protruding upward from the two longitudinal frames. The one or more bottom supporting frames are two bottom supporting frames respectively connected to the two transverse frames, and the two longitudinal frames are buckled to the two bottom supporting frames respectively through the buckling structure.

In some possible embodiments, a length of each of the two bottom supporting frames in the longitudinal direction is less than or equal to half the length of each of the two longitudinal frames in the longitudinal direction.

In some possible embodiments, a side of each of the two bottom supporting frames adjacent to the corresponding one of the two transverse frames forms two position-avoiding portions recessed inwardly. When the two longitudinal frames are folded inward and each of the two bottom supporting frames is parallel to the corresponding one of the two transverse frames, the sub-buckling member is at least partially located below the two position-avoiding portions.

In some possible embodiments, the two longitudinal frames are obtained by pivotally connecting two half-frames.

Each of the two half-frames comprises an upper rod, a lower rod, and a side rod. The upper rod and the lower rod are arranged in parallel, and the side rod is perpendicular to the upper rod. An end portion of the upper rod and an end portion of the lower rod are connected by the side rod, and the upper rod, the lower rod, and the side rod are integrally formed.

Ends of the upper rods of the two half-frames away from the side rods are pivotally connected, and ends of the lower rods of the two half-frames away from the side rods are pivotally connected to form a corresponding one of the two longitudinal frames.

In some possible embodiments, each of the two longitudinal frames further comprises a pivoting member, and the pivoting member comprises two sleeves opposite to each other. Each of the two sleeves comprises two openings facing away from each other, and ends of each of the two sleeves away from the two openings are connected by a hinge.

The upper rods of the two half-frames are respectively disposed in a first one of the two sleeves of the pivoting member, so that the upper rods of the two half-frames are connected.

The lower rods of the two half-frames are respectively disposed in a second one of the two sleeves of the pivoting member, so that the lower rods of the two half-frames are connected.

In some possible embodiments, the sub-buckling member is disposed on the second one of the two sleeves.

In some possible embodiments, the rollers are disposed at ends of the one or more connecting rods adjacent to the connecting protrusion, and a distance between two opposite rollers of the rollers connected to different transverse frames of the two transverse frames is greater than a distance between outer edges of the two transverse frames.

A method for packaging a spring mattress is provided. The spring mattress comprises an upper cushioning layer, an elastic module, and a bottom plate, which are detachable relative to each other. The upper cushioning layer is a cushioning layer. The elastic module is formed by detachably connecting a plurality of spring units, and the bottom plate is formed by detachably splicing a plurality of bottom plate units.

The method for packaging the spring mattress comprises packaging the spring mattress using a packaging device, and the packaging device comprises a plurality of independent packaging containers and the packaging supporting frame.

The packaging the spring mattress using the packaging device comprises packaging the upper cushioning layer in one of the plurality of independent packaging containers, packaging the bottom plate in at least one of the plurality of independent packaging containers, packaging the elastic module in at least second one of the plurality of independent packaging containers, and stacking and placing the plurality of independent packaging containers on the packaging supporting frame.

In some possible embodiments, the method for packaging the spring mattress comprises locking the elastic module in a compressed state when the elastic module is received in the at least second one of the plurality of independent packaging containers.

In some possible embodiments, the method for packaging the spring mattress comprises stacking and storing the plurality of bottom plate units in the at least one of the plurality of independent packaging containers after being assembled.

In some possible embodiments, the method for packaging the spring mattress comprises storing the upper cushioning layer in the one of the plurality of independent packaging containers after being folded or rolled up.

In some possible embodiments, handle holes are provided on two opposite side walls of each of the plurality of independent packaging containers.

In some possible embodiments, a handle is provided on a top surface of each of the plurality of independent packaging containers.

In some possible embodiments, the packaging device further comprises an entire packaging container. The method for packaging the spring mattress comprises stacking and storing the plurality of independent packaging containers a in the entire packaging container. The entire packaging container is stored in the packaging supporting frame.

The present disclosure has at least the following beneficial effects:
1. The method for packaging the spring mattress and the packaging device provided by the present disclosure reduces a packaging volume by packaging the upper cushioning layer, the plurality of spring units defining the elastic module, and the plurality of bottom plate units defining the bottom plate in separate packaging containers and stacking them for transportation. This saves space and manpower during manual handling and transportation, and prevents damage and deformation of the spring mattress components due to improper stacking.
2. By stacking the plurality of independent packaging containers on the packaging supporting frame, merchants can easily transport the plurality of independent packaging containers when shipping or users can move the plurality of independent packaging containers, saving labor costs. In some possible implementations, the plurality of independent packaging containers are stacked and stored in the entire packaging container, which can secure the stacked independent packaging containers, making the stack more secure.

### BRIEF DESCRIPTION OF THE DRAWINGS

FIG. 1 is a perspective view of a spring mattress in Embodiment 1.

FIG. 2 is a perspective view of an upper cushioning layer, an elastic module, and a bottom plate of the spring mattress in Embodiment 1, wherein only a portion of the elastic module is shown to illustrate a structure of the bottom plate.

FIG. 3 is a perspective view of the elastic module in Embodiment 1.

FIG. 4 is a perspective view of the elastic module locked in a compressed state in Embodiment 1.

FIG. 5 is a perspective view of the bottom plate in Embodiment 1.

FIG. 6 is a perspective view of the bottom plate in Embodiment 1 being split into a plurality of bottom plate units.

FIG. 7 is a perspective view of the upper cushioning layer after being rolled up and stored in a first packaging container in Embodiment 1, and to make a structural relationship between the upper cushioning layer and the first packaging container clearer, handle holes on the first packaging container are omitted in FIG. 7.

FIG. 8 is a perspective view of the first packaging container in Embodiment 1.

FIG. 9 is a perspective view of a third packaging container in Embodiment 1.

FIG. 10 is a perspective view of the elastic module of Embodiment 1, and the elastic module is divided into a group of multiple spring units, locked in the compressed state, and then stored in a second packaging container.

FIG. 11 is a perspective view of the second packaging container in Embodiment 1.

FIG. 12 is a perspective view of a plurality of independent packaging containers stacked and stored in a packaging supporting frame in Embodiment 1.

FIG. 13 is a bottom view of FIG. 12.

FIG. 14 is a perspective view of two groups of packaging devices stacked in a height direction in Embodiment 1.

FIG. 15 is a perspective view of the packaging supporting frame in Embodiment 1 in a folded state.

FIG. 16 is a perspective view of the packaging supporting frame in Embodiment 1, wherein two bottom supporting frames are parallel to two transverse frames, and two longitudinal frames are in a state between an unfolded state and a folded state.

FIG. 17 is a perspective view of the packaging supporting frame in Embodiment 1, wherein the two bottom supporting frames are parallel to the two transverse frames and the two longitudinal frames are in the unfolded state.

FIG. 18 is a perspective view of the packaging supporting frame in Embodiment 1, wherein an acute angle is formed between a plane where the two bottom supporting frames are located and a plane where the two transverse frames to which the two bottom supporting frames are connected, and the two longitudinal frames are in the unfolded state;

FIG. 19 is a perspective view of the packaging supporting frame in Embodiment 1, wherein the two bottom supporting frames are perpendicular to the two transverse frames and are buckled to the two longitudinal frames through a buckling structure.

FIG. 20 is a side view of a plurality of independent packaging containers stacked and stored in a packaging supporting frame in Embodiment 2, wherein to illustrate a relationship between the plurality of independent packaging containers and the packaging supporting frame, an entire packaging container is omitted in this figure.

FIG. 21 is a perspective view of the entire packaging container being stored in the packaging supporting frame in Embodiment 2.

### DETAILED DESCRIPTION OF THE EMBODIMENTS

The technical solutions in the embodiments of the present disclosure will be clearly and completely described below in conjunction with the drawings in the embodiments of the present disclosure. It is obvious that the described embodiments are only part of the embodiments of the present disclosure, rather than all the embodiments. Based on the embodiments of the present disclosure, all other embodiments obtained by ordinary technicians in this field without making creative work are within the scope of protection of the present disclosure.

In the description of the present disclosure, it should be noted that the terms “upper,” “lower,” “inner,” “outer,” “top,” “bottom,” and the like, indicating orientations or positional relationships, are based on the orientations or positional relationships shown in the accompanying drawings and are intended solely to facilitate and simplify the description of the present disclosure. They are not intended to indicate or imply that the devices or components referred to must have, be constructed, or operate in a specific orientation, and therefore should not be construed as limitations on the present disclosure. Furthermore, the terms “first” and “second” are used for descriptive purposes only and should not be construed as indicating or implying relative importance.

In the description of the present disclosure, it should be noted that, unless otherwise clearly stipulated and limited, the terms “installed”, “provided with”, “sleeved on”, “connected”, etc. should be understood in a broad sense. For example, “connection” can be a wall-mounted connection, a detachable connection, or an integral connection. It can be a mechanical connection or an electrical connection. It can be a direct connection or an indirect connection through an intermediate medium. It can be an internal connection of two components. For ordinary technicians in this field, the specific meanings of the above terms in the present disclosure can be understood according to specific circumstances.

### Embodiment 1

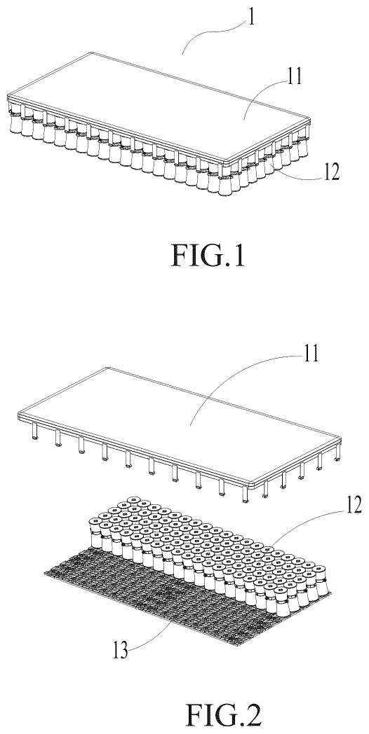

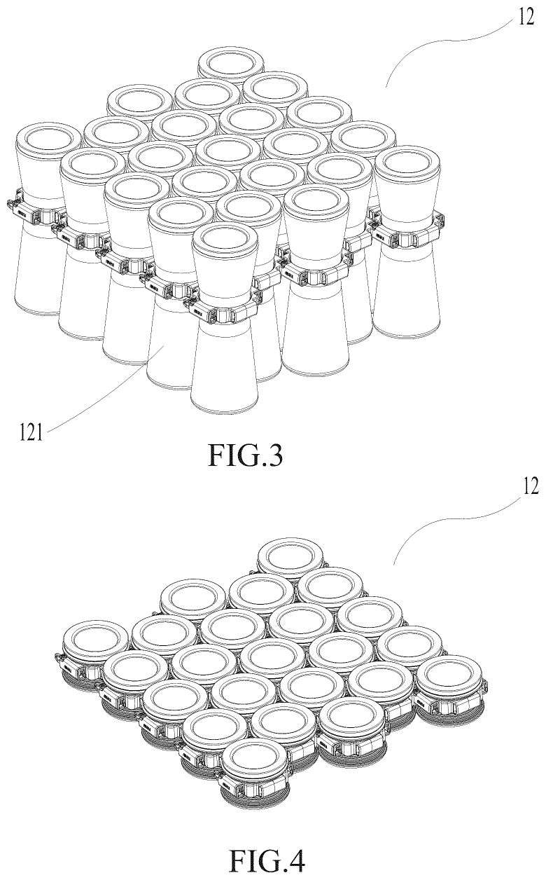

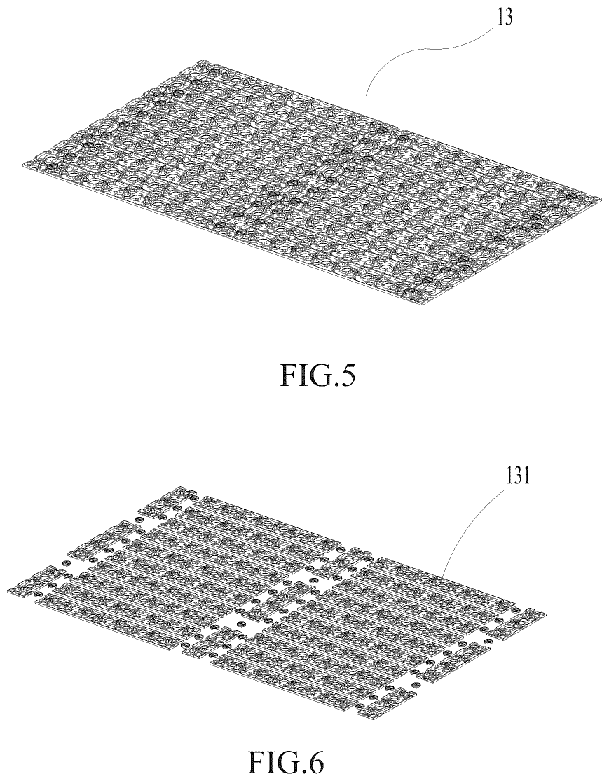

This embodiment provides a packaging supporting frame 2 for a detachable spring mattress 1, and a packaging method for using the packaging supporting frame 2 for packaging and transporting the detachable spring mattress 1. As shown in FIGS. 1 and 2, the detachable spring mattress 1 comprises an upper cushioning layer 11, an elastic module 12, and a bottom plate 13, which are detachable relative to each other. The upper cushioning layer 11 is a soft cushioning layer, and the elastic module 12 is formed by detachably connecting a plurality of spring units 121. The plurality of spring units 121 can be compressed from a state shown in FIG. 3 to a state shown in FIG. 4. As shown in FIGS. 5 and 6, the bottom plate 13 is formed by detachably splicing a plurality of bottom plate units 131. When shipping or when users are transporting the detachable spring mattress 1, the detachable spring mattress 1 can be disassembled into the upper cushioning layer 11, the plurality of spring units 121, and the plurality of bottom plate units 131 for packaging.

A packaging device of the detachable spring mattress 1 of this embodiment comprises a plurality of independent packaging containers and the packaging supporting frame 2. Specifically, the plurality of independent packaging containers are divided into at least one first packaging container 31 for packaging the upper cushioning layer 11, at least one second packaging container 32 for packaging the plurality of spring units 121, and at least one third packaging container 33 for packaging the plurality of bottom plate units 131.

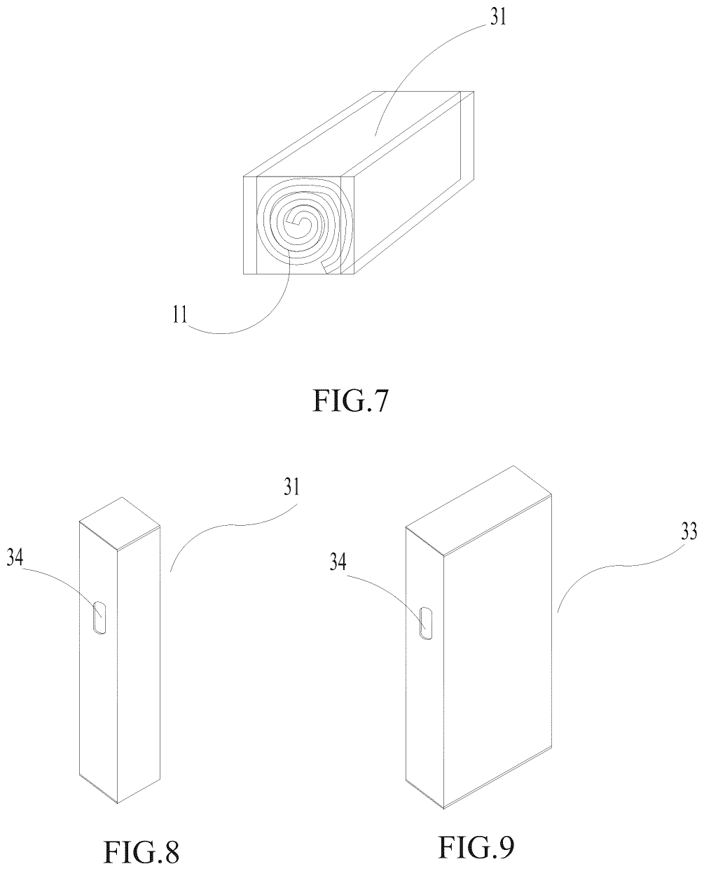

Because the upper cushioning layer 11 is a soft cushioning layer, the upper cushioning layer 11 can be folded or rolled up and then placed into the at least one first packaging container 31. In this embodiment, the at least one first packaging container 31 is an elongated rectangular packaging box as shown in FIGS. 7 and 8, and the upper cushioning layer 11 is rolled up and placed into the elongated rectangular packaging box. As a simple alternative to this embodiment, the at least one first packaging container 31 can also be a flat packaging box, and the upper cushion layer 11 can be folded and placed into the flat packaging box. A shape and a size of the at least one first packaging container 31 are specifically selected according to a volume and a size of the upper cushioning layer 11 and are not particularly limited, as long as the purpose of the present disclosure can be achieved.

The bottom plate 13 is split into the plurality of bottom plate units 131 as shown in FIG. 6, and then the plurality of bottom plate units 131 are stacked and placed into the at least one third packaging container 33 as shown in FIG. 9. As a simple alternative to this embodiment, when the bottom plate 13 is made of a flexible material, the at least one third packaging container 33 is two or fewer third packaging containers 33, and the bottom plate 13 can also be folded and packaged in two or fewer third packaging containers 33.

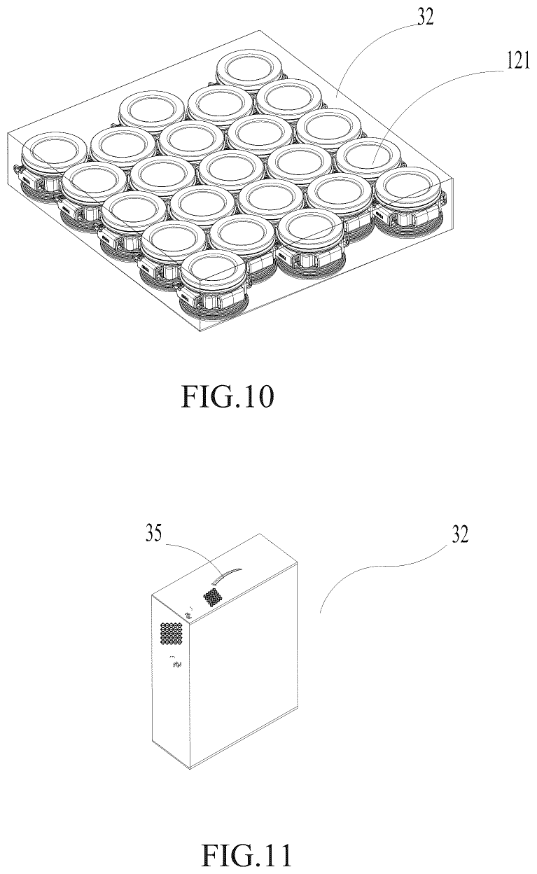

To pack more of the plurality of spring units 121 into the at least one second packaging container 32 and save transportation volume, in this embodiment, the plurality of spring units 121 arranged in an array are divided into one or more modules, which are then disassembled from one another, rather than separating each of the plurality of spring units 121. Then, as shown in FIGS. 10 and 11, the plurality of spring units 121 of the one or more modules are locked in a compressed state, and the one or more modules are stacked in the at least one second packaging container 32.

As a simple alternative to this embodiment, each of the plurality of spring units 121 can be individually disassembled, compressed to a locked state, and then stacked in the at least one second packaging container 32. The plurality of spring units 121 can then be stacked in the at least one second packaging container 32 in a pattern of N1×N2×N3, where N1 is greater than or equal to 1, N2 is greater than or equal to 1, and N3 is greater than or equal to 1. Specifically, the plurality of spring units 121 can be stacked in a 1*10 pattern in a second elongated rectangular packaging box, or in multiple rows and columns such as 2*5 or 4*5 in a second flat packaging box, or in multiple rows, columns, or groups such as 2*5*5 in a cubic packaging box.

Furthermore, as shown in FIGS. 8 and 9, two opposite side walls of each of the plurality of independent packaging containers has handle holes 34 to facilitate removal of the plurality of independent packaging containers. Alternatively, as shown in FIG. 11, a top surface (or a side) of each of the plurality of independent packaging containers is disposed with a handle 35.

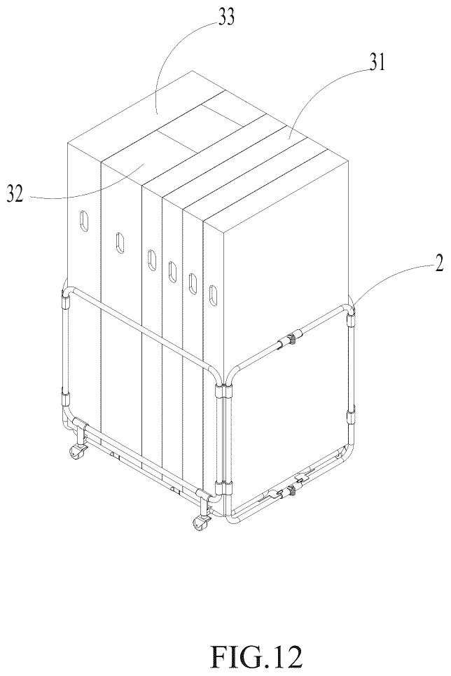

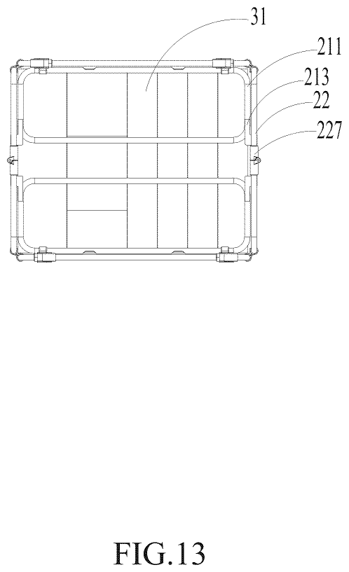

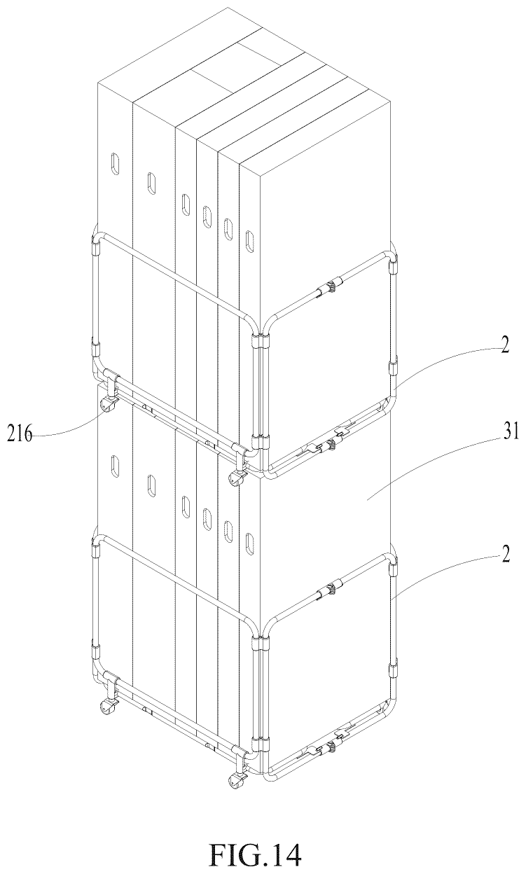

As shown in FIGS. 12 and 13, the at least one first packaging container 31, the at least one second packaging container 32, and the at least one third packaging container 33, which have been packaged, are stacked and stored in the packaging supporting frame 2. The packaging supporting frame 2 securely holds the plurality of individual packaging containers in a compact arrangement and facilitates manual handling and transportation. The packaging devices can be stacked vertically as illustrated in FIG. 14.

As a simple alternative to this embodiment, the at least one first packaging container 31, the at least one second packaging container 32, and the at least one third packaging container 33 can be freely combined and stacked on the packaging supporting frame 2. It is possible to simultaneously stack all three types of the at least one first packaging container 31, the at least one second packaging container 32, and the at least one third packaging container 33, or optionally stack any two types or just one type of the at least one first packaging container 31, the at least one second packaging container 32, and the at least one third packaging container 33.

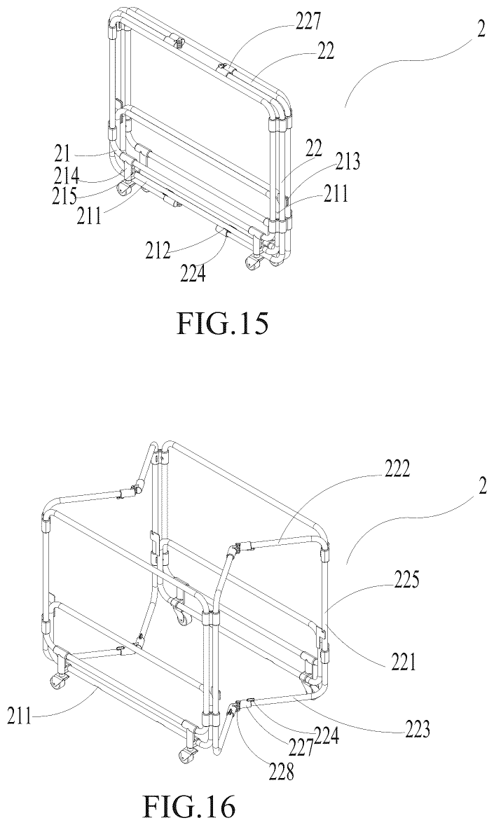

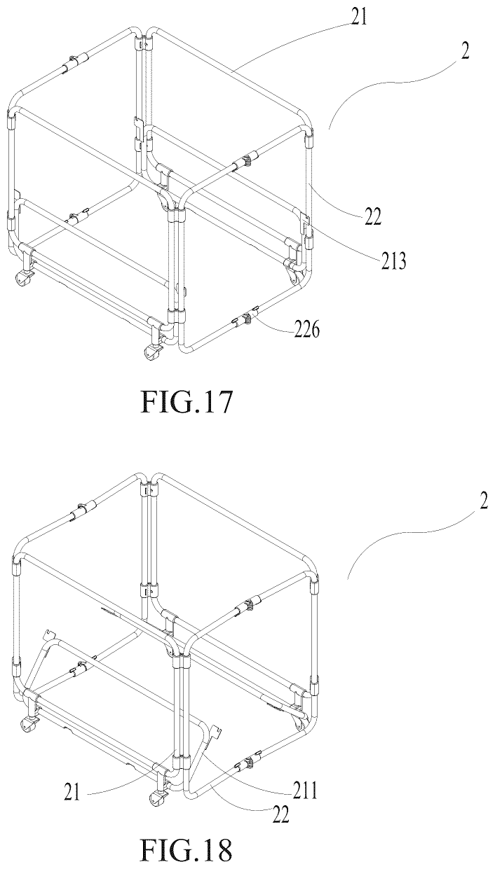

A structure of the packaging supporting frame 2 is described in detail below with reference to FIGS. 15-19. The packaging supporting frame 2 comprises two transverse frames 21 opposite to each other, two longitudinal frames 22 opposite to each other, and rollers 216. Two ends of each of the transverse frames 21 are rotatably connected to corresponding ends of the two longitudinal frames 22, and the rollers 216 are located at bottoms of the two transverse frames 21. The bottoms of the two transverse frames 21 are connected with one or more bottom supporting frames 211 (e.g., the one or more bottom supporting frames 211 are two bottom supporting frames 211 respectively connected to the two transverse frames 21). Each of the one or more bottom supporting frames 211 can be rotated to form an angle between 0°and 90°with a corresponding one of the two transverse frames 21 to which the one or more bottom supporting frames 211 are connected. As shown in FIG. 16, when the one or more bottom supporting frames 211 are rotated perpendicular to the two transverse frames 21, two ends of each of the one or more bottom supporting frames 211 in a transverse direction are respectively connected to corresponding ends of the two longitudinal frames 22 through a buckling structure. A transverse length of each of the two transverse frames 21 is twice a longitudinal length of each of the two longitudinal frames 22. The rollers 216 are located at the bottoms of the two transverse frames 21 or bottoms of the two longitudinal frames 22.

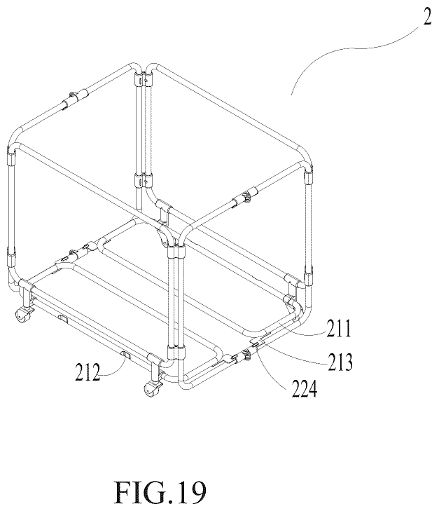

Each of the two longitudinal frames 22 is formed by two half-frames 221 pivotally connected together by a pivoting member 226. Each of the two half-frames 221 comprises an upper rod 222, a lower rod 223, and a side rod 225, which are integrally formed. The upper rod 222 and the lower rod 223 are arranged parallel to each other, and the side rod 225 is perpendicular to the upper rod 222. An end portion of the upper rod 222 and an end portion of the lower rod 223 are connected by the side rod 225. The upper rod 222, the lower rod 223, and the side rod 225 are integrally formed. The pivoting member 226 comprises two sleeves 227 opposite to each other. Each of the two sleeves 227 comprises two openings 2271 facing away from each other. Two ends of each of the two sleeves 227 away from the two openings 2271 are connected by a hinge 228. The upper rods 222 of the two half-frames 221 are respectively inserted into a first one of the two sleeves 227 of the pivoting member 226, so that the upper rods 222 of the two half-frames 221 are connected. The lower rods 223 of the two half-frames 221 are respectively inserted into a second one of the two sleeves 227 of the pivoting member 226, so that the lower rods 223 of the two half-frames 221 are connected. The two half-frames 221 are unfolded or folded together through the pivoting member 226, allowing the two longitudinal frames 22 to be unfolded (as shown in FIG. 19) and folded inward (as shown in FIG. 15). Due to a rotatable connection between the two longitudinal frames 22 and the two transverse frames 21, inward folding of the two longitudinal frames 22 pulls the two transverse frames 21 to be adjacent to each other, so as to achieve folding of the packaging supporting frame 2. Because the transverse length of each of the two transverse frames 21 is twice the longitudinal length of each of the two longitudinal frames 22, when the two longitudinal frames 22 are folded inward, the two longitudinal frames 22 will not interfere with each other, allowing the two longitudinal frames 22 to be folded completely in half. This results in a relatively small thickness for the packaging supporting frame 2, which has been folded.

Each of the one or more bottom supporting frames 211 is connected to the corresponding one of the two transverse frames 21 through two connecting rods 214. Specifically, a first end of each of the two connecting rods 214 is connected to the corresponding one of the two transverse frames 21, and a second end of each of the two connecting rods 214 forms a connecting protrusion 215 protruding inward to the packaging supporting frame 2. A corresponding one of the one or more bottom supporting frames 211 is pivotally connected to the connecting protrusions 215 of the two connecting rods 214 and can be rotated around a pivoting point of the corresponding one of the one or more bottom supporting frames 211 on the connecting protrusions 215, so that an angle of approximately 0-90°is formed between the corresponding one of the one or more bottom supporting frames 211 and the corresponding one of the two transverse frames 21 to which the corresponding one of the one or more bottom supporting frames 211 is connected.

A length of each of the one or more bottom supporting frames 211 in the transverse direction is slightly less than a distance between the two longitudinal frames 22, and the two connecting protrusions 215 are higher in height than the lower rod 223 of each of the two longitudinal frames 22. This arrangement ensures that when the packaging supporting frame 2 is folded, the one or more bottom supporting frames 211 and the two longitudinal frames 22 are located in a same vertical plane and do not interfere with each other. Two sides of each of the one or more bottom supporting frames 211 are disposed with a female buckling member 213, and the female buckling member 213 comprises buckling plates 2131, each of which has a buckling opening in a height direction. Corresponding positions on the two longitudinal frames 22 are disposed with a sub-buckling member 224, and the sub-buckling member 224 comprises buckling protrusions 2241 protruding upwardly. The female buckling member 213 and the sub-buckling member 224 define the buckling structure of this embodiment. When the one or more bottom supporting frames 211 are perpendicular to the two transverse frames 21, the one or more bottom supporting frames 211 and the two longitudinal frames 22 are buckled together by the buckling structure. Furthermore, the sub-buckling member 224 is arranged on the second one of the two sleeves 227 of the pivoting member 226, and a side of each of the one or more bottom supporting frames 211 adjacent to the corresponding one of the two transverse frames 21 forms two position-avoiding portions 212 recessed inwardly. When the two longitudinal frames 22 are folded inward and each of the one or more bottom supporting frames 211 are parallel to the corresponding one of the two transverse frames 21, the sub-buckling member 224 is at least partially located below the two position-avoiding portions 212, and the female buckling member 213 is located between two vertical planes formed by the two groups of the one or more bottom supporting frames 211 and the two longitudinal frames 22 respectively. Since the buckling plates 2131 are thin sheets, arranging four buckling plates 2131 (i.e., the one or more bottom supporting frames 211 are two bottom supporting frames 211, and the female buckling member 213 of each of the two bottom supporting frames 211 comprises two buckling plates 2131) between the two vertical planes has little effect on a thickness of the packaging supporting frame 2 when folded.

Furthermore, the rollers 216 are disposed at ends of two connecting rods 214 adjacent to connecting protrusions 215. A distance between two opposite rollers 216 of the rollers 216 connected to different transverse frames 21 is greater than a distance between outer edges of the two transverse frames 21. This allows two packaging devices to be stacked in a vertical direction, as shown in FIG. 14, without damaging the plurality of independent packaging containers or the spring mattress 1 therein. As a simple alternative to this embodiment, the rollers 216 may also be provided at the bottoms of the two longitudinal frames 22.

When a merchant ships the detachable spring mattress 1 or a user needs to transport the detachable spring mattress 1, components of the detachable spring mattress 1 can be separated into the upper cushioning layer 11, the elastic module 12, and the bottom plate 13, and then packaged in the at least one first packaging container 31, the at least one second packaging container 32, and the at least one third packaging container 33 according to the above method. Finally, the at least one first packaging container 31, the at least one second packaging container 32, and the at least one third packaging container 33, which have been packaged, are stacked on the packaging supporting frame 2.

Compared with traditional packaging and transportation methods, in this embodiment, when transporting, the detachable spring mattress 1 is split into smaller units and stored in the plurality of independent packaging containers, which can enable the user to save more effort when transporting. Then, during transportation, the plurality of independent packaging containers are compacted and stabilized by the packaging supporting frame 2, and the packaging supporting frame 2 is provided with the rollers 216 to make transportation more convenient and labor-saving.

### Embodiment 2

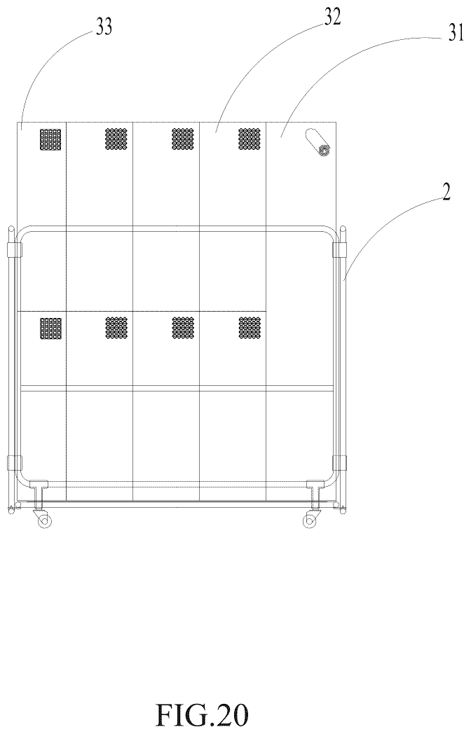

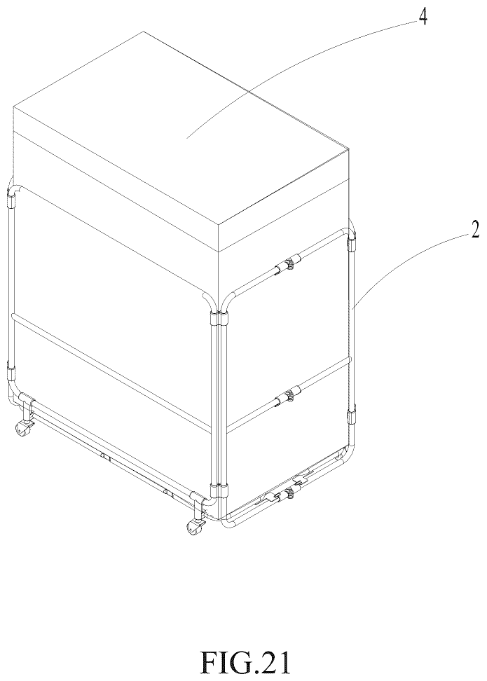

The difference between Embodiment 2 and Embodiment 1 is that the packaging device further comprises an entire packaging container 4. In this embodiment, as shown in FIGS. 20 and 21, the plurality of independent packaging containers are stacked vertically and then stored in the entire packaging container 4, which is then stored in the packaging supporting frame 2. The entire packaging container 4 secures the plurality of independent packaging containers, which are stacked relative to each other, making the stack more secure.

The above are merely preferred embodiments of the present disclosure, and therefore should not be used to limit the scope of the present disclosure. In other words, equivalent changes and modifications made according to the scope of the present disclosure and the contents of the specification should still fall within the scope of the present disclosure.

What is claimed is:

1. A packaging supporting frame for a spring mattress, comprising:
two transverse frames opposite to each other, two longitudinal frames opposite to each other, and rollers, wherein:
the two longitudinal frames are configured to be folded inward,
bottoms of the two transverse frames are connected with one or more bottom supporting frames,
each of the one or more bottom supporting frames is configured to be rotated to form an angle between 0°and 90°with a corresponding one of the two transverse frames to which a corresponding one of the one or more bottom supporting frames is connected,
when the one or more bottom supporting frames are rotated perpendicular to the two transverse frames, two ends of each of the one or more bottom supporting frames in a transverse direction are respectively connected to the two longitudinal frames through a buckling structure,
two ends of each of the transverse frames are rotatably connected to corresponding ends of the two longitudinal frames,
a length of each of the two transverse frames in the transverse direction is greater than or equal to twice a length of each of the two longitudinal frames in a longitudinal direction, and
the rollers are arranged at the bottoms of the two transverse frames or bottoms of the two longitudinal frames.

2. The packaging supporting frame according to claim 1, wherein:
each of the one or more bottom supporting frames is connected to the corresponding one of the two transverse frames through one or more connecting rods,
each of the one or more bottom supporting frames and the corresponding one of the two transverse frames are respectively connected to two ends of each of the one or more connecting rods, and
the corresponding one of the one or more bottom supporting frames is configured to be rotated relative to the one or more connecting rods.

3. The packaging supporting frame according to claim 2, wherein:
a body of the one or more connecting rods and the corresponding one of the two transverse frames are in a same vertical plane,
a connecting protrusion protruding inwardly is formed at one end of each of the one or more connecting rods away from the corresponding one of the two transverse frames, and
the corresponding one of the one or more bottom supporting frames is rotatably connected to the connecting protrusion.

4. The packaging supporting frame according to claim 3, wherein:
a length of each of the one or more bottom supporting frames in the transverse direction is less than or equal to a distance between the two longitudinal frames.

5. The packaging supporting frame according to claim 2, wherein:
a connection point between the corresponding one of the one or more bottom supporting frames and the one or more connecting rods is higher than the bottoms of the two longitudinal frames in a height direction, and
when the one or more bottom supporting frames are parallel to the two transverse frames and the two longitudinal frames are folded inward, the one or more bottom supporting frames and the two longitudinal frames do not interfere with each other.

6. The packaging supporting frame according to claim 5, wherein:
the one or more connecting rods are two connecting rods, and
each of the one or more bottom supporting frames is connected to the corresponding one of the two transverse frames through the two connecting rods.

7. The packaging supporting frame according to claim 1, wherein:
the buckling structure comprises a female buckling member arranged at the two ends of the corresponding one of the one or more bottom supporting frames in the transverse direction and a sub-buckling member formed by protruding upward from the two longitudinal frames,
the one or more bottom supporting frames are two bottom supporting frames respectively connected to the two transverse frames, and
the two longitudinal frames are buckled to the two bottom supporting frames respectively through the buckling structure.

8. The packaging supporting frame according to claim 7, wherein:
a length of each of the two bottom supporting frames in the longitudinal direction is less than or equal to half the length of each of the two longitudinal frames in the longitudinal direction.

9. The packaging supporting frame according to claim 7, wherein:
a side of each of the two bottom supporting frames adjacent to the corresponding one of the two transverse frames forms two position-avoiding portions recessed inwardly, and
when the two longitudinal frames are folded inward and each of the two bottom supporting frames is parallel to the corresponding one of the two transverse frames, the sub-buckling member is at least partially located below the two position-avoiding portions.

10. The packaging supporting frame according to claim 9, wherein:
the two longitudinal frames are obtained by pivotally connecting two half-frames,
each of the two half-frames comprises an upper rod, a lower rod, and a side rod,
the upper rod and the lower rod are arranged in parallel,
the side rod is perpendicular to the upper rod,
an end portion of the upper rod and an end portion of the lower rod are connected by the side rod,
the upper rod, the lower rod, and the side rod are integrally formed,
ends of the upper rods of the two half-frames away from the side rods are pivotally connected, and
ends of the lower rods of the two half-frames away from the side rods are pivotally connected to form a corresponding one of the two longitudinal frames.

11. The packaging supporting frame according to claim 10, wherein:
each of the two longitudinal frames further comprises a pivoting member,
the pivoting member comprises two sleeves opposite to each other,
each of the two sleeves comprises two openings facing away from each other,
ends of each of the two sleeves away from the two openings are connected by a hinge,
the upper rods of the two half-frames are respectively disposed in a first one of the two sleeves of the pivoting member, so that the upper rods of the two half-frames are connected, and
the lower rods of the two half-frames are respectively disposed in a second one of the two sleeves of the pivoting member, so that the lower rods of the two half-frames are connected.

12. The packaging supporting frame according to claim 11, wherein:
the sub-buckling member is disposed on the second one of the two sleeves.

13. The packaging supporting frame according to claim 3, wherein:
the rollers are disposed at ends of the one or more connecting rods adjacent to the connecting protrusion, and
a distance between two opposite rollers of the rollers connected to different transverse frames of the two transverse frames is greater than a distance between outer edges of the two transverse frames.

14. A method for packaging a spring mattress, wherein:
the spring mattress comprises an upper cushioning layer, an elastic module, and a bottom plate, which are detachable relative to each other,
the upper cushioning layer is a cushioning layer,
the elastic module is formed by detachably connecting a plurality of spring units,
the bottom plate is formed by detachably splicing a plurality of bottom plate units,
the method for packaging the spring mattress comprises:
packaging the spring mattress using a packaging device, and
the packaging device comprises a plurality of independent packaging containers and the packaging supporting frame according to claim 1,
the packaging the spring mattress using the packaging device comprises:
packaging the upper cushioning layer in one of the plurality of independent packaging containers,
packaging the bottom plate in at least one of the plurality of independent packaging containers,
packaging the elastic module in at least second one of the plurality of independent packaging containers, and
stacking and placing the plurality of independent packaging containers on the packaging supporting frame.

15. The method for packaging the spring mattress according to claim 14, comprising:
locking the elastic module in a compressed state when the elastic module is received in the at least second one of the plurality of independent packaging containers.

16. The method for packaging the spring mattress according to claim 14, comprising:
stacking and storing the plurality of bottom plate units in the at least one of the plurality of independent packaging containers after being assembled.

17. The method for packaging the spring mattress according to claim 14, comprising:
storing the upper cushioning layer in the one of the plurality of independent packaging containers after being folded or rolled up.

18. The method for packaging the spring mattress according to claim 14, wherein:
handle holes are provided on two opposite side walls of each of the plurality of independent packaging containers.

19. The method for packaging the spring mattress according to claim 14, wherein:
a handle is provided on a top surface of each of the plurality of independent packaging containers.

20. The method for packaging the spring mattress according to claim 14, wherein:
the packaging device further comprises an entire packaging container,
the method for packaging the spring mattress comprises:
stacking and storing the plurality of independent packaging containers a in the entire packaging container, and
the entire packaging container is stored in the packaging supporting frame.
